(19) United States
(12) Patent Application Publication
(10) Pub. No.: US 2024/0283539 A1
(43) Pub. Date: Aug. 22, 2024

(54) RECEIVING DEVICE, COMMUNICATION DEVICE, AND COMMUNICATION SYSTEM

(71) Applicant: NEC Corporation, Tokyo (JP)

(72) Inventors: Hisashi Mizumoto, Tokyo (JP); Fujio Okumura, Kanagawa (JP); Masaki Aizono, Tokyo (JP)

(73) Assignee: NEC Corporation, Tokyo (JP)

(21) Appl. No.: 18/411,174

(22) Filed: Jan. 12, 2024

(30) Foreign Application Priority Data
Feb. 17, 2023 (JP) 2023-023183

(51) Int. Cl. H04B 10/40; H04B 10/516; H04B 10/60

(52) U.S. Cl. CPC H04B 10/40; H04B 10/516; H04B 10/60

(57) ABSTRACT

A receiving device includes a notification light transmitter that transmits notification light in a direction along a horizontal plane, a ball lens disposed below the notification light transmitter, a plurality of light receivers disposed in a condensing region of the ball lens and each including a first light receiving element that receives notification light transmitted from a communication target and a second light receiving element that receives communication light transmitted from the communication target, and a moving mechanism on which the ball lens is disposed and that movably supports the plurality of light receivers in accordance with the condensing region of the ball lens.

This application is based upon and claims the benefit of priority from Japanese Patent Application No. 2023-023183, filed on Feb. 17, 2023, the disclosure of which is incorporated herein in its entirety by reference.

### TECHNICAL FIELD

The present disclosure relates to a receiving device, a communication device, and a communication system.

### BACKGROUND ART

In spatial light communication in a free space, an optical signal (hereinafter, also referred to as a spatial light signal) propagating in the space is transmitted and received without using a medium such as an optical fiber. The spatial light signal used in the optical space communication has higher directivity than that of a radio wave used in wireless communication. The spatial light signal does not interfere with the radio wave. In the field of spatial light communication, an optical communication network can be constructed using optical communication devices facing each other. Since the spatial light signal has high directivity, communication is interrupted when the spatial light signal is physically blocked by a shielding object. Therefore, in spatial light communication, an optical communication network made redundant by simultaneous multi-directional connection is required in order to implement a stable optical communication environment.

PTL 1 (JP S63-095407 A) discloses an optical space transmission module that transmits a spatial light signal. The optical space transmission module described in PTL 1 includes a light emitting unit, a pedestal unit, and a reflection diffusion unit. The light emitting unit outputs transmission light. The pedestal unit includes a reflection unit that reflects the transmission light. The reflection unit has a function of increasing a beam diameter after the reflection of the transmission light. The reflection diffusion unit converts the transmission light reflected by the reflection unit into diffused light and reflects the diffused light.

In the optical space transmission module described in PTL 1, the beam diameter after the reflection of the transmission light is increased by the reflection unit. According to the method described in PTL 1, since a range in which the spatial light signal is received is expanded according to the increase in the beam diameter, it is possible to notify more communication targets of the position of the optical space transmission module. In the method described in PTL 1, a range in which the spatial light signal is transmitted is limited to the orientation of the reflection diffusion unit. Therefore, in the method described in PTL 1, the position of the optical space transmission module cannot be notified to a communication target in directions of 360 degrees along a horizontal plane.

An object of the present disclosure is to provide a receiving device, a communication device, and a communication system capable of implementing spatial light communication using a spatial light signal with a communication target in directions of 360 degrees along a horizontal plane.

### SUMMARY

A receiving device according to one aspect of the present disclosure includes a notification light transmitter that transmits notification light in a direction along a horizontal plane, a ball lens disposed below the notification light transmitter, a plurality of light receivers each including a first light receiving element that is disposed in a condensing region of the ball lens and receives notification light transmitted from a communication target, and a second light receiving element that receives communication light transmitted from the communication target, and a moving mechanism on which the ball lens is disposed and that movably supports the plurality of light receivers in accordance with the condensing region of the ball lens.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a configuration of a communication device according to the present disclosure;

FIG. 2 is a conceptual diagram illustrating an example of a configuration of a transmitting device included in the communication device according to the present disclosure;

FIG. 3 is a conceptual diagram illustrating an example of an optical member included in the transmitting device included in the communication device according to the present disclosure;

FIG. 4 is a conceptual diagram illustrating another example of the optical member included in the transmitting device included in the communication device according to the present disclosure;

FIG. 5 is a conceptual diagram illustrating an example of a configuration of a receiving device included in the communication device according to the present disclosure;

FIG. 6 is a conceptual diagram illustrating an example of an internal configuration of the receiving device included in the communication device according to the present disclosure;

FIG. 7 is a conceptual diagram illustrating an example of a light receiver included in the receiving device included in the communication device according to the present disclosure;

FIG. 8 is a conceptual diagram illustrating a state for describing a condensing region of light condensed by a ball lens included in the receiving device included in the communication device according to the present disclosure;

FIG. 9 is a conceptual diagram illustrating a state for describing a light irradiation range at a position A in the condensing region of the ball lens included in the receiving device included in the communication device according to the present disclosure;

FIG. 10 is a conceptual diagram illustrating a state for describing a light irradiation range at a position B in the condensing region of the ball lens included in the receiving device included in the communication device according to the present disclosure;

FIG. 11 is a conceptual diagram illustrating an example of a configuration of a communication control device included in the communication device according to the present disclosure;

FIG. 12 is a conceptual diagram for describing a radiation pattern of notification light transmitted from the communication device according to the present disclosure;

FIG. 13 is a conceptual diagram illustrating an example of a configuration of a light receiving position adjustment unit included in the reception control unit included in the communication device according to the present disclosure;

FIG. 14 is a conceptual diagram for describing first position control by the communication device according to the present disclosure;

FIG. 15 is a conceptual diagram for describing second position control by the communication device according to the present disclosure;

FIG. 16 is a conceptual diagram illustrating a state in which a light spot of notification light and a light receiving unit of a second light receiving element overlap each other by the first position control and the second position control by the communication device according to the present disclosure;

FIG. 17 is a conceptual diagram illustrating an example of a communication network configured by communication devices according to the present disclosure;

FIG. 18 is a conceptual diagram illustrating transmission and reception of notification light in the communication network configured by the communication devices according to the present disclosure;

FIG. 19 is a conceptual diagram illustrating an example of a configuration of a transmitting device according to the present disclosure;

FIG. 20 is a conceptual diagram for describing an example of detection of a communication target using image data captured by a camera included in the transmitting device according to the present disclosure;

FIG. 21 is a conceptual diagram for describing an example of reception of notification light by the transmitting device according to the present disclosure;

FIG. 22 is a conceptual diagram for describing an example in which positions of a plurality of curved mirrors are adjusted according to the reception of the notification light by the transmitting device according to the present disclosure.

FIG. 23 is a conceptual diagram for describing processing in which the transmitting device according to the present disclosure establishes spatial light communication using communication light with communication targets;

FIG. 24 is a conceptual diagram illustrating an example of a configuration of a transmitting device according to a first modification of the present disclosure;

FIG. 25 is a conceptual diagram for describing an example of reception of notification light by the transmitting device according to the first modification of the present disclosure;

FIG. 26 is a conceptual diagram illustrating an example of a configuration of a receiving device according to the present disclosure;

FIG. 27 is a conceptual diagram illustrating an example of the configuration of the receiving device according to the present disclosure; and

FIG. 28 is a block diagram illustrating an example of a hardware configuration that executes processing and control according to the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of arrows in the drawings are merely examples, and do not limit the directions of light and signals. Lines indicating trajectories of light in the drawings are conceptual, and do not accurately indicate actual traveling directions or states of light. For example, in the drawings, a change in a traveling direction or a state of light due to refraction, reflection, diffusion, or the like at an interface between air and a substance may be omitted, or a light flux may be expressed by one line. Hatching may not be applied to a cross section for reasons such as illustration of an example of a light path and a complicated configuration.

### First Example Embodiment

First, a communication device according to a first example embodiment will be described with reference to the drawings. The communication device according to the present example embodiment is used for optical space communication in which an optical signal (hereinafter, also referred to as a spatial light signal) propagating in a space is transmitted and received. The communication device according to the present example embodiment may be used for applications other than optical space communication as long as the communication device is used for transmitting and receiving light propagating in a space. The drawings used in the description of the present example embodiment are conceptual and do not accurately depict actual structures.

### (Configuration)

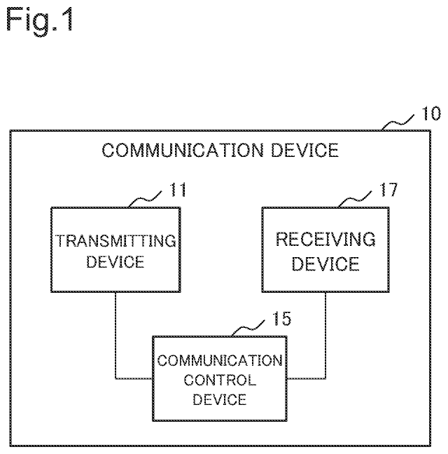

FIG. 1 is a conceptual diagram illustrating an example of a configuration of a communication device 10 according to the present disclosure. FIG. 1 is a diagram of an internal configuration of the communication device 10 as viewed from a side perspective. The communication device 10 includes a transmitting device 11, a communication control device 15, and a receiving device 17. The communication device 10 transmits and receives spatial light signals to and from an external communication target. Therefore, an opening or a window for transmitting and receiving a spatial light signal is formed in the communication device 10.

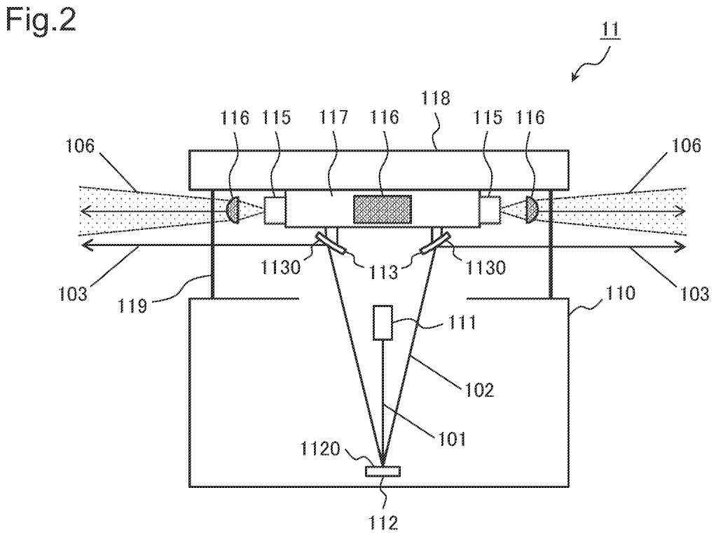

FIG. 2 is a conceptual diagram illustrating an example of a configuration of the transmitting device 11. The transmitting device 11 includes a housing 110, a first light source 111, a spatial light modulator 112, a curved mirror 113, second light sources 115, an optical member 116, a support 117, a lid 118, and a window member 119. The first light source 111, the spatial light modulator 112, and the curved mirror 113 constitute a communication light transmitter. The second light sources 115 and the optical member 116 constitute a notification light transmitter.

The housing 110 stores the first light source 111 and the spatial light modulator 112. The curved mirror 113, the second light sources 115, the optical member 116, the support 117, the lid 118, and the window member 119 are disposed in an upper part of the housing 110. An opening through which light 102 modulated by the spatial light modulator 112 passes is formed in the housing 110. The opening of the housing 110 is formed in an optical path of the modulated light 102. The size and position of the opening of the housing 110 are not limited as long as the optical path of the modulated light 102 is not hindered.

The first light source 111 is disposed above the spatial light modulator 112. An emission surface of the first light source 111 is oriented toward a modulation part 1120 of the spatial light modulator 112. The first light source 111 includes at least one light emitter (not illustrated). The light emitter emits illumination light 101 under the control of the communication control device 15. The illumination light 101 emitted from the first light source 111 is applied to the modulation part 1120 of the spatial light modulator 112.

The light emitter included in the first light source 111 emits laser light in a predetermined wavelength band under the control of the communication control device 15. A wavelength of the laser light emitted from the light emitter is not particularly limited, and may be selected according to the application. For example, the light emitter emits laser light in a visible or infrared wavelength band. For example, since near infrared light of 800 to 1000 nanometers (nm) can be classified as a laser class as compared with visible light, sensitivity can be improved as compared with visible light. For example, in a case where infrared light in a wavelength band of 1.55 micrometers (μm) is used, a laser light source having a higher output than near infrared light of 800 to 1000 nm can be used. As a laser light source that emits infrared light in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger a diffraction angle can be made and the higher energy can be set. For example, the light emitter may be a surface emitting element such as a photonic crystal surface emitting laser (PCSEL).

Each of a plurality of light emitters is associated with any one of a plurality of modulation regions set in the modulation part 1120 of the spatial light modulator 112. Illumination light 101 emitted from each of the plurality of light emitters travels toward the modulation region associated with the light emitter.

The spatial light modulator 112 is a phase modulation type spatial light modulator. The spatial light modulator 112 includes the modulation part 1120. For example, the spatial light modulator 112 is implemented by a spatial light modulator using ferroelectric liquid crystal, homogeneous liquid crystal, vertical alignment liquid crystal, or the like. For example, the spatial light modulator 112 can be implemented by liquid crystal on silicon (LCOS). The spatial light modulator 112 may be implemented by a micro electro mechanical system (MEMS). In the phase modulation type spatial light modulator 112, energy can be concentrated on a portion of an image by operating to sequentially switch a place where communication light 103 is projected. Therefore, in a case where the phase modulation type spatial light modulator 112 is used, when outputs of light emitters included in the first light source 111 are the same, an image can be displayed brighter than other methods.

The plurality of modulation regions are set in the modulation part 1120 of the spatial light modulator 112. The number of modulation regions set in the modulation part 1120 is set in accordance with the number of light emitters included in first light source 111. Each of the plurality of modulation regions is associated with a respective one of the plurality of light emitters included in the first light source 111. Each of the plurality of modulation regions is irradiated with illumination light 101 derived from the laser light emitted from light emitter associated with the modulation region. However, correspondence relationships between the modulation regions and the light emitters are not particularly limited as long as illumination light 101 derived from laser light emitted from the light emitters is incident on modulation surfaces of the modulation regions.

Each of the modulation regions is divided into a plurality of regions (also referred to as tiling). For example, each of the modulation regions is divided into regions (also referred to as tiles) of a desired aspect ratio. A phase image is allocated to each of the plurality of tiles. Each of the plurality of tiles includes a plurality of pixels. A phase image corresponding to a projected image is set in each of the plurality of tiles. A phase image is tiled to each of the plurality of tiles allocated to the modulation region. For example, a phase image generated in advance is set in each of the plurality of tiles. When the modulation region is irradiated with the illumination light 101 in a state in which the phase images are set in the plurality of tiles, the modulated light 102 that forms an image corresponding to the phase image of each of the tiles is emitted. As the number of tiles set in each of the modulation regions increases, a clear image can be displayed. However, when the number of pixels of each tile decreases, the resolution decreases. Therefore, the size and number of tiles set in each of the modulation regions are set according to the application.

A pattern (also referred to as a phase image) corresponding to an image displayed by the communication light 103 is set in each of the plurality of modulation regions under the control of the communication control device 15. The illumination light 101 enters each of the plurality of modulation regions set in the modulation part 1120. The illumination light 101 is modulated according to a pattern (phase image) set in each of the plurality of modulation regions. The light 102 modulated in each of the plurality of modulation regions travels toward a reflecting surface 1130 of the curved mirror 113.

For example, a shield (not illustrated) may be disposed at a subsequent stage of the spatial light modulator 112. The shield is a frame that shields an unnecessary light component included in the modulated light 102 and defines an outer edge of a display region for the communication light 103. For example, the shield is an aperture. In such an aperture, a slit-shaped opening is formed in a portion through which light (desired light) that forms a desired image passes. The desired light is first-order diffracted light. The desired light passes through the shield, and the shield shields an unnecessary light component. For example, the shield shields a ghost image including 0th-order light included in the modulated light 102, unnecessary first-order light appearing at a point symmetric with respect to the desired light with the 0th-order light as the center, and higher-order light that is second-order or higher-order light. Details of the shield will not be described.

The curved mirror 113 is a reflector having the curved reflecting surface 1130. The curved mirror 113 is disposed at a subsequent stage of the spatial light modulator 112. The curved mirror 113 is disposed on a lower surface of the support 117. A circular rail (not illustrated) having a circular shape is arranged on the lower surface of the support 117. The curved mirror 113 is installed in such a way as to be movable along the circular rail. The position of the curved mirror 113 is changed under the control of the communication control device 15. The position of the curved mirror 113 is changed in response to the detection of the notification light from the communication target in such a way that the reflecting surface 1130 faces toward the arrival direction of the notification light.

The reflecting surface 1130 of the curved mirror 113 has a curvature corresponding to a projection angle at which the communication light 103 is projected. For example, the reflecting surface 1130 has a shape of a side surface of a cylinder. For example, the reflecting surface 1130 may be a free-form surface or a spherical surface. For example, the reflecting surface 1130 may not be a single curved surface but may have a shape obtained by combining a plurality of curved surfaces. The reflecting surface 1130 may be a flat surface. In a case where the reflecting surface 1130 is a flat surface, an adjustment range of the projection angle at which the communication light 103 is projected is narrower than that when the reflecting surface 1130 is a curved surface. In a case where the reflecting surface 1130 is a flat surface, the communication light 103 reaches a far place because the spread of the communication light 103 is small, as compared with a case where the reflecting surface 1130 is a curved surface. For example, the reflecting surface 1130 may have a shape obtained by combining a curved surface and a flat surface.

The curved mirror 113 is disposed with the reflecting surface 1130 facing the modulation part 1120 of the spatial light modulator 112. The curved mirror 113 is disposed in the optical path of the modulated light 102. The reflecting surface 1130 of the curved mirror 113 is irradiated with the modulated light 102. The light (communication light 103) reflected by the reflecting surface 1130 is projected as a spatial light signal. The communication light 103 is enlarged according to the curvature of an irradiation range of the modulated light 102 on the reflecting surface 1130 of the curved mirror 113. For example, a lens (not illustrated) may be disposed at a subsequent stage of the curved mirror 113 in order to limit the spread of the communication light 103.

The light 102 modulated by the modulation part 1120 of the spatial light modulator 112 includes an unnecessary light component (also referred to as unnecessary light). The unnecessary light is zero-order light or high-order light included in the modulated light 102. The curved mirror 113 is disposed at a position where the reflecting surface 1130 is not irradiated with the unnecessary light. The reflecting surface 1130 is irradiated with a light component (also referred to as desired light) to be projected out of the light 102 modulated by the modulation part 1120. The modulated light 102 applied to the reflecting surface 1130 is reflected by the reflecting surface 1130. The light (communication light 103) reflected by the reflecting surface 1130 is enlarged and projected at an enlargement ratio corresponding to the curvature of the reflecting surface 1130. The communication light 103 spreads as the communication light 103 goes away from the communication device 10.

The reflecting surface 1130 of the curved mirror 113 is oriented in directions of 360 degrees in a horizontal plane. Therefore, the transmitting device 11 can project the communication light 103 in the directions of 360 degrees in the horizontal plane by controlling a pattern (phase image) set in the modulation part 1120 of the spatial light modulator 112. The transmitting device 11 can simultaneously transmit the communication light 103 (spatial light signal) toward communication targets arranged in a plurality of directions by associating the plurality of modulation regions set in the modulation part 1120 with different directions.

In the configuration illustrated in FIG. 2, the light 102 modulated by the modulation part 1120 of the spatial light modulator 112 travels toward the reflecting surface 1130 of the curved mirror 113. The modulated light 102 may be reflected in multiple stages by using at least one folding mirror and travel toward the reflecting surface 1130 of the curved mirror 113. For example, an annular first folding mirror centered on the optical path of the illumination light 101 is arranged inside the circular rail in which the curved mirror 113 is installed. Then, an annular second folding mirror centered on the spatial light modulator 112 is arranged in a plane where the spatial light modulator 112 is arranged. The radius of the first folding mirror is smaller than the radius of the second folding mirror. The radius of the first folding mirror is set in such a way that the modulated light 102 reflected by the reflecting surface 1130 of the curved mirror 113 travels to a reflecting surface of the first folding mirror. The radius of the second folding mirror is set in such a way that the modulated light 102 reflected by the first folding mirror travels toward a reflecting surface of the second folding mirror. The radius of the circular rail in which the curved mirror 113 is installed is set in such a way that the modulated light 102 reflected by the second folding mirror travels toward the reflecting surface 1130 of the curved mirror 113. In this way, the light 102 modulated by the modulation part 1120 of the spatial light modulator 112 is sequentially reflected by the first folding mirror and the second folding mirror, and then reaches the reflecting surface 1130 of the curved mirror 113. The folding mirror may include three or more mirrors. With this configuration, the distance between the spatial light modulator 112 and the curved mirror 113 can be reduced with respect to the diameter of the curved mirror 113, and thus the transmitting device 11 can be thinned in the thickness direction.

The second light sources 115 (also referred to as notification light sources) emit radiation light that will be projected at a larger projection angle (radiation angle) than the communication light 103. For example, each of the second light sources 115 includes a light-emitting diode (LED). For example, the second light sources 115 emit radiation light in a wavelength band of 850 to 950 nanometers. The transmitting device 11 includes the plurality of second light sources 115. The plurality of second light sources 115 are disposed with their radiation surfaces facing a direction parallel to the horizontal plane. The plurality of second light sources 115 are disposed with their radiation surfaces facing different directions. The optical member 116 is disposed in directions of the radiation surfaces of the second light sources 115.

The optical member 116 is a member for projecting the radiation light emitted from the second light sources 115 as notification light 106. In FIG. 2, a structure for supporting the optical member 116 is omitted. Incident surfaces of the optical member 116 face the radiation surfaces of the second light sources 115. The incident surfaces of the optical member 116 are irradiated with the radiation light emitted from the second light sources 115. Emission surfaces of the optical member 116 are oriented in a direction parallel to the horizontal plane. The radiation light with which the incident surfaces of the optical member 116 are irradiated is emitted from the emission surfaces as the notification light 106. The notification light 106 is light for notifying a communication target arranged at the same height as the horizontal plane on which the communication device 10 is arranged of the position of the transmitting device 11.

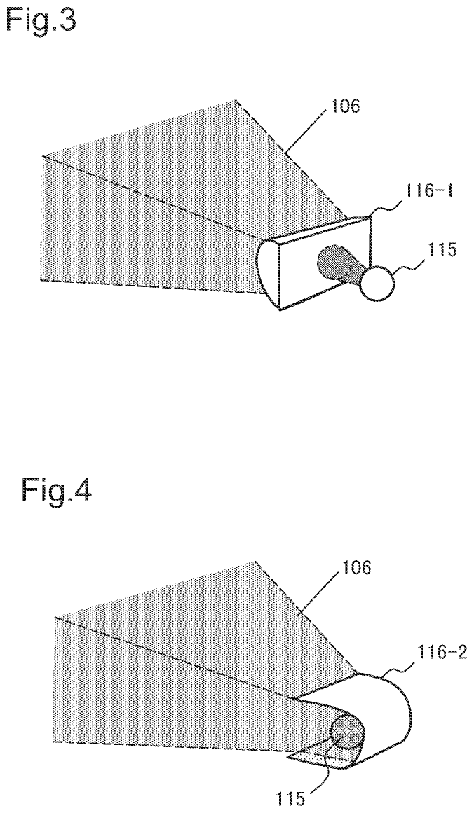

FIG. 3 illustrates an example in which the optical member 116 is implemented by a cylindrical lens (optical member 116-1). The optical member 116-1 is a plano-convex cylindrical lens including a flat surface and a curved surface. The flat surface of the optical member 116-1 is an incident surface, and a convex surface of the optical member 116-1 is an emitting surface. The flat surface (incident surface) of the optical member 116-1 faces the radiation surface of the second light source 115. Radiation light incident from the flat surface (incident surface) of the optical member 116-1 is radiated as the notification light 106 from the convex surface (emitting surface) of the optical member 116-1.

FIG. 4 illustrates an example in which the optical member 116 is implemented by a concave mirror (optical member 116-2) having a curvature in the vertical direction. A concave surface of the optical member 116-2 is a reflecting surface. The concave surface (reflecting surface) of the optical member 116-2 faces the emitting surface of the second light source 115. Radiation light applied to the concave surface (reflecting surface) of the optical member 116-2 is reflected by the concave surface (reflecting surface) and emitted as the notification light 106.

The support 117 is a structure that supports the curved mirror 113 and the second light sources 115. A circular rail for movably installing the curved mirror 113 is disposed on the lower surface of the support 117. The plurality of second light sources 115 are arranged on a side surface of the support 117. A power source and a drive unit used for driving the second light sources 115 and moving the curved mirror 113 are disposed inside the support 117. The communication control device 15 may be disposed inside the support 117.

The lid 118 is disposed above the window member 119. The support 117 is disposed on a lower surface of the lid 118. The material and shape of the lid 118 are not particularly limited.

The window member 119 is a member that removes unnecessary light and selectively transmits a spatial light signal to be used for communication. The window member 119 serves as a support column for placing the lid 118 thereon. The material of the window member 119 is not particularly limited as long as light in the wavelength band of the spatial light signal is transmitted and the window member is not deformed even when the lid 118 is placed on the window member 119. The communication light 103 and the notification light 106 travel through the window member 119.

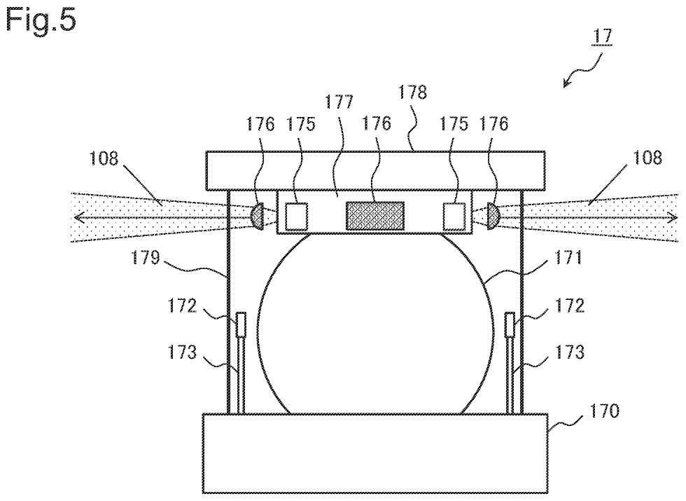

FIG. 5 is a conceptual diagram illustrating an example of a configuration of the receiving device 17. The receiving device 17 includes a base 170, a ball lens 171, light receivers 172, support columns 173, third light sources 175, an optical member 176, a support 177, a lid 178, and a window member 179. The ball lens 171, the light receivers 172, and the support columns 173 constitute a receiver. The third light sources 175 and the optical member 176 constitute a notification light transmitter. The notification light transmitter of the receiving device 17 has a configuration similar to that of the notification light transmitter of the transmitting device 11. The base 170 and the support 177 are a moving mechanism for changing the positions of the light receivers 172. In the present example embodiment, an example in which the transmitting device 11 and the receiving device 17 include a notification light transmitter will be described. The notification light transmitter may be disposed in at least one of the transmitting device 11 and the receiving device 17.

The base 170 is a table that supports the ball lens 171, the light receivers 172, and the support columns 173. A recess or an opening for arranging the ball lens 171 is formed in the center of an upper surface of the base 170. The ball lens 171 is disposed in the recess or opening formed in the center of the upper surface of the base 170. The circular rail having the circular shape is arranged on the upper surface of the base 170 in such a way as to annularly surround the recess or opening formed in the center. The circular rail has a circumference overlapping with a condensing region of the ball lens 171 in plan view. The support columns 173 are movably installed on the circular rail arranged on the upper surface of the base 170.

The ball lens 171 is a spherical lens. The ball lens 171 is an optical element that condenses the spatial light signal (communication light, notification light) arriving from the outside. The ball lens 171 has a spherical shape as viewed from an arbitrary angle. The ball lens 171 condenses the incident spatial light signal. Light (also referred to as an optical signal) derived from the spatial light signal condensed by the ball lens 171 is condensed toward the condensing region of the ball lens 171. Since the ball lens 171 has a spherical shape, the ball lens 171 condenses a spatial light signal arriving from an arbitrary direction. That is, the ball lens 171 exhibits similar light condensing performance for a spatial light signal arriving from an arbitrary direction. The light incident on the ball lens 171 is refracted when entering the inside of the ball lens 171. The light traveling inside the ball lens 171 is refracted again when being emitted to the outside of the ball lens 171. Most of the light emitted from the ball lens 171 is condensed toward the condensing region.

For example, the ball lens 171 can be made of a material such as glass, crystal, or resin. In the case of receiving a spatial light signal in the visible region, a material such as glass, crystal, or resin that transmits and refracts light in the visible region can be used for the ball lens 171. For example, optical glass such as crown glass or flint glass can be used for the ball lens 171. For example, crown glass such as Boron Kron (BK) can be used for the ball lens 171. For example, a flint glass such as Lanthanum Schwerflint (LaSF) can be used for the ball lens 171. For example, quartz glass can be used for the ball lens 171. For example, a crystal such as sapphire can be used for the ball lens 171. For example, a transparent resin such as acryl can be used for the ball lens 171.

In a case where the spatial light signal is light (hereinafter, also referred to as near infrared light) in a near-infrared region, a material that transmits near-infrared light is used for the ball lens 171. For example, in a case of receiving a spatial light signal in a near-infrared region of about 1.5 micrometers (μm), a material such as silicon can be used for the ball lens 171 in addition to glass, crystal, resin, and the like. In a case where the spatial light signal is light (hereinafter, also referred to as infrared light) in an infrared region, a material that transmits infrared rays is used for the ball lens 171. For example, in a case where the spatial light signal is infrared light, silicon, germanium, or a chalcogenide material can be used for the ball lens 171. The material of the ball lens 171 is not limited as long as light in the wavelength region of the spatial light signal can be transmitted and refracted in the ball lens 171. The material of the ball lens 171 may be appropriately selected according to the required refractive index and use.

The light receivers 172 are disposed in a condensing region including a condensing point of the ball lens 171 in a state of being supported by the support columns 173. The condensing point of the ball lens 171 is not uniquely determined. Therefore, the light receivers 172 are disposed in the condensing region including the condensing point of the ball lens 171. In the example illustrated in FIG. 5, the light receivers 172 are disposed on the side of the ball lens 171. Light receiving surfaces of the light receivers 172 are oriented toward the center of the ball lens 171. The plurality of light receivers 172 are arranged in an annular portion surrounding the periphery of the ball lens 171.

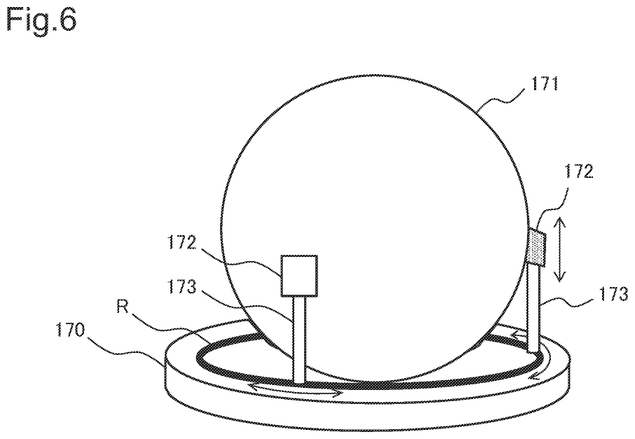

FIG. 6 is a conceptual diagram of the base 170, the ball lens 171, the light receivers 172, and the support columns 173 viewed from an obliquely upper perspective. The circular rail R is arranged on the upper surface of the base 170. The support columns 173 are disposed on the circular rail R. The support columns 173 move along the circular rail R. The heights of the light receivers 172 are changed in accordance with expansion and contraction of the support columns 173. The positions of the light receivers 172 in the horizontal plane are changed in accordance with the positions of the support columns 173. Therefore, the positions of the light receiving surfaces of the light receivers 172 can be adjusted in accordance with the expansion and contraction of the support columns 173 and the positions of the support columns 173.

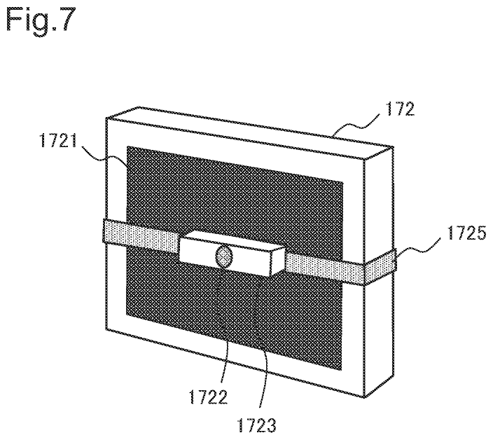

FIG. 7 is a perspective view of the light receiver 172 as viewed from the light receiving surface side. The light receiver 172 includes a first light receiving element 1721, a second light receiving element 1722, a support 1723, and wiring 1725. The second light receiving element 1722 is installed on the wiring 1725 via the support 1723.

The first light receiving element 1721 is used to receive the notification light. A light receiving surface of the first light receiving element 1721 has a larger area than that of a light receiving surface of the second light receiving element 1722. The first light receiving element 1721 has sensitivity to light in the wavelength band of the notification light. For example, the first light receiving element 1721 is implemented by a silicon-based photodiode. The light receiving surface of the first light receiving element 1721 is divided into two by the wiring 1725. The notification light received by the first light receiving element 1721 is converted into an electric signal. The converted electric signal is output to the communication control device 15.

The second light receiving element 1722 is used to receive the communication light 103 for communication. The light receiving surface of the second light receiving element 1722 has a smaller area than that of the light receiving surface of the first light receiving element 1721. The second light receiving element 1722 has sensitivity to light in the wavelength band of the communication light 103. For example, the second light receiving element 1722 is implemented by a photodiode having sensitivity to infrared light. For example, the second light receiving element 1722 is implemented by an indium gallium arsenide (InGaAs)-based photodiode. The communication light 103 received by the second light receiving element 1722 is converted into an electric signal. The converted electric signal is output to the communication control device 15.

The support columns 173 are columns that support the light receivers 172. The light receivers 172 are disposed on the support columns 173. Each of the support columns 173 has a structure that extends and contracts in the vertical direction. The support columns 173 vertically move up and down under the control of the communication control device 15. Lower portions of the support columns 173 are installed in such a way as to be movable with respect to the circular rail R arranged on the upper surface of the base 170. The positions of the support columns 173 are changed along the circular rail R under the control of the communication control device 15.

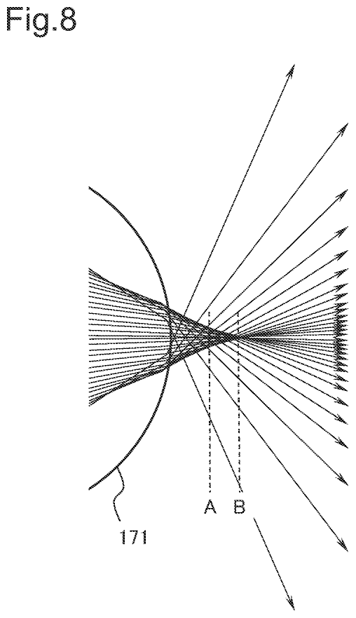

The reception of the communication light 103 by the light receivers 172 will be described with reference to the drawings. FIG. 8 is a conceptual diagram for explaining the intensity of light in a light receiving region of the ball lens 171. FIG. 8 is a conceptual diagram of a part of the ball lens 171 as viewed from a side perspective. The intensity of light in the light receiving region of the ball lens 171 changes in accordance with the position from the ball lens 171.

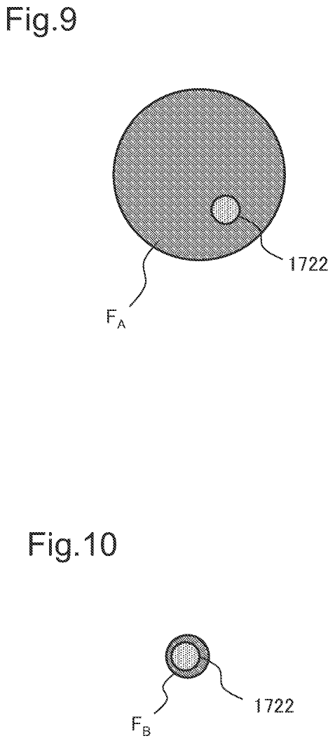

FIG. 9 is a conceptual diagram for explaining a light irradiation range F_{A} at a position A illustrated in FIG. 8. FIG. 10 is a conceptual diagram for explaining a light irradiation range F_{B} at a position B illustrated in FIG. 8. FIGS. 9 and 10 are conceptual diagrams of the light receiving surface of the second light receiving element 1722 viewed from a perspective of the ball lens 171. A light flux density at the position B far from the ball lens 171 is higher than a light flux density at the position A close to the ball lens 171, and thus the intensity of received light at the position B far from the ball lens 171 is higher than the intensity of received light at the position A close to the ball lens 171. Therefore, the light receiving surface of the second light receiving element 1722 is adjusted to the position B rather than the position A in such a way that the light receiving efficiency is higher. However, a light irradiation area at the position B far from the ball lens 171 is smaller than a light irradiation area at the position A close to the ball lens 171, and thus it is difficult to keep the light receiving surface of the second light receiving element 1722 within the irradiation range FB. In the present example embodiment, the second light receiving element 1722 is disposed at the position B where the intensity of the received light is high. As will be described later, in the present example embodiment, the position of the light receiving surface of the second light receiving element 1722 is optimized in order to receive the communication light 103 having a high intensity.

The third light sources 175 (also referred to as notification light sources) emit radiation light similarly to the second light sources 115. For example, each of the third light sources 175 includes a light-emitting diode (LED). The receiving device 17 includes the plurality of third light sources 175. The plurality of third light sources 175 are disposed with their radiation surfaces facing a direction parallel to the horizontal plane. The plurality of third light sources 175 are disposed with their radiation surfaces facing different directions. The optical member 176 is disposed in directions of the radiation surfaces of the third light sources 175.

The optical member 176 has a similar configuration to that of the optical member 116 of the transmitting device 11. The optical member 176 is a member for projecting the radiation light emitted from the third light sources 175 as notification light 108. In FIG. 5, a structure for supporting the optical member 176 is omitted. Incident surfaces of the optical member 176 face the radiation surfaces of the third light sources 175. The incident surfaces of the optical member 176 are irradiated with the radiation light emitted from the third light sources 175. Emission surfaces of the optical member 176 are oriented in a direction parallel to the horizontal plane. The radiation light with which the incident surfaces of the optical member 176 are irradiated is emitted from the emission surfaces as the notification light 108. The notification light 108 is light for notifying the communication target arranged at the same height as the horizontal plane on which the communication device 10 is arranged of the position of the receiving device 17.

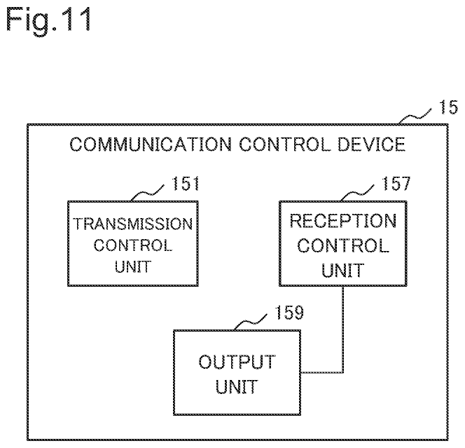

FIG. 11 is a block diagram illustrating an example of a configuration of the communication control device 15. The communication control device 15 includes a transmission control unit 151, a reception control unit 157, and an output unit 159. For example, the communication control device 15 is implemented by a microcomputer including a processor and a memory.

The transmission control unit 151 (transmission control means) controls the second light sources 115. The transmission control unit 151 controls the second light sources 115 in such a way that the notification light 106 is emitted with a modulation pattern unique to the communication device 10 at the timing of emitting the notification light 106.

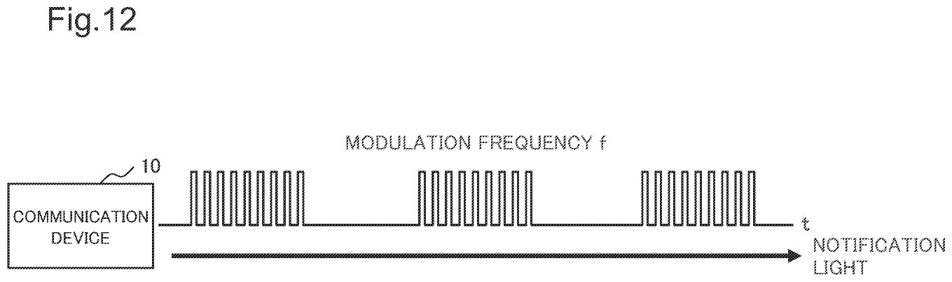

FIG. 12 is a conceptual diagram for describing a radiation pattern of the notification light 106 transmitted from the communication device 10 under the control of the transmission control unit 151. The transmission control unit 151 controls the second light sources 115 in such a way that the notification light 106 modulated with a unique modulation frequency f is emitted at emission timings set at a predetermined time interval. The modulation frequency f is not particularly limited. For example, the modulation frequency f is set to about 300 hertz. The timings of emitting the notification light 106 are set to a radiation pattern unique to the communication device 10. The timings of emitting the notification light 106 may be a constant time interval or a preset regularly changing time interval. The timings of the notification light 106 may be a time interval that randomly changes. In order to identify each communication device 10, the modulation frequency of the notification light 106 is set to a modulation pattern unique to each communication device 10. For example, the modulation frequency of the notification light 106 may be configured in such a way that each communication device 10 can be identified by a pattern of the timings of emitting the notification light 106.

The transmission control unit 151 controls the first light source 111 and the spatial light modulator 112. The transmission control unit 151 sets a phase image corresponding to an image to be projected in the modulation part 1120. The transmission control unit 151 sets a phase image corresponding to the image to be projected in each modulation region set in the modulation part 1120 of the spatial light modulator 112. The phase image of the image to be projected may be stored in advance in a storage unit (not illustrated). The shape and size of the image to be projected are not particularly limited.

The transmission control unit 151 controls the spatial light modulator 112 in such a way that a parameter that determines a difference between a phase of the illumination light 101 emitted to the modulation part 1120 and a phase of the modulated light 102 reflected by the modulation part 1120 changes. For example, the parameter is a value related to optical characteristics such as a refractive index and an optical path length. For example, the transmission control unit 151 adjusts the refractive index of the modulation part 1120 by changing a voltage applied to the modulation part 1120 of the spatial light modulator 112. A phase distribution of the illumination light 101 with which the modulation part 1120 of the phase modulation type spatial light modulator 112 is irradiated is modulated according to the optical characteristics of the modulation part 1120. The method of driving the spatial light modulator 112 by the transmission control unit 151 is determined according to the modulation scheme of the spatial light modulator 112.

The transmission control unit 151 drives the first light source 111 in a state in which a phase image corresponding to a displayed image is set in the modulation part 1120 of the spatial light modulator 112. As a result, in a state in which the phase image is set in the modulation part 1120, the modulation part 1120 is irradiated with the illumination light 101 emitted from the first light source 111. The illumination light 101 applied to the modulation part 1120 is modulated by the modulation part 1120. The light 102 modulated by the modulation part 1120 travels toward the reflecting surface 1130 of the curved mirror 113.

The transmission control unit 151 modulates the illumination light 101 emitted from the first light source 111 for communication with a communication target (not illustrated). In communication, the transmission control unit 151 controls the timing at which the illumination light 101 is emitted from the first light source 111 in a state in which a phase image for communication is set in the modulation part 1120 of the spatial light modulator 112. By the control, the illumination light 101 is modulated. The modulation pattern of the illumination light 101 in the communication is arbitrarily set. In addition to the transmission control unit 151, a communication unit (not illustrated) is included. The transmission control unit 151 may be configured to control the first light source 111 and the spatial light modulator 112 according to a condition set by the communication unit.

The reception control unit 157 (reception control means) controls the third light sources 175. The reception control unit 157 controls the third light sources 175 in such a way that the notification light 108 is emitted with a modulation pattern unique to the communication device 10 at a timing of emitting the notification light 108. The transmission control of the notification light 108 by the third light sources 175 is similar to the transmission control of the notification light 108 by the second light sources 115 of the transmitting device 11.

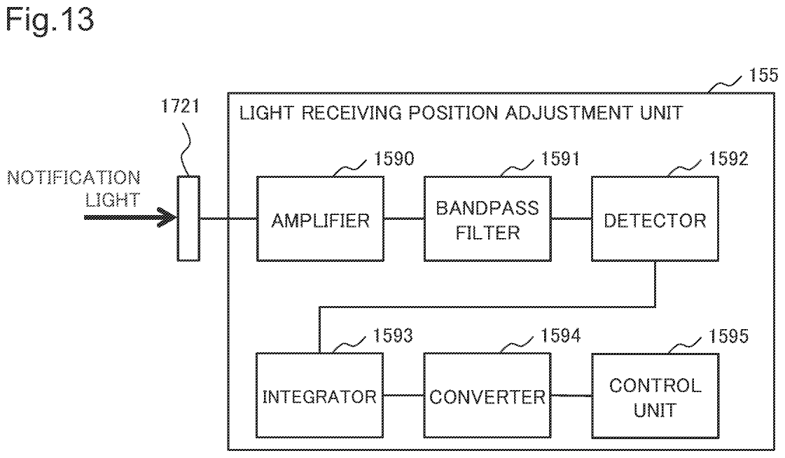

FIG. 13 is a block diagram illustrating an example of a configuration of a light receiving position adjustment unit 155 included in the reception control unit 157. The light receiving position adjustment unit 155 (light receiving position adjustment means) controls the positions of the light receivers 172 according to the reception of notification light. The light receiving position adjustment unit 155 includes an amplifier 1590, a bandpass filter 1591, a detector 1592, an integrator 1593, a converter 1594, and a control unit 1595.

The amplifier 1590 is disposed at a subsequent stage of the first light receiving element 1721. An electric signal derived from the notification light received by the first light receiving element 1721 is input to the amplifier 1590. The amplifier 1590 amplifies the input electric signal.

The bandpass filter 1591 is arranged at a subsequent stage of the amplifier 1590. The electric signal amplified by the amplifier 1590 is input to the bandpass filter 1591. The bandpass filter 1591 passes a signal of a frequency band to be received.

The detector 1592 is disposed at a subsequent stage of bandpass filter 1591. The detector 1592 detects a modulated signal to be received from the signal that has passed through bandpass filter 1591. The detector 1592 outputs the detected modulated signal.

The integrator 1593 is disposed at a subsequent stage of the detector 1592. The integrator 1593 acquires the modulated signal output from the detector 1592. The integrator 1593 integrates the acquired modulated signal. By using the integrator 1593, it is possible to track weak light. The integrator 1593 outputs the integrated modulated signal.

The converter 1594 is disposed at a subsequent stage of the integrator 1593. The converter 1594 acquires the modulated signal integrated by the integrator 1593. The converter 1594 converts the integrated modulated signal (analog signal) into a digital signal. The converter 1594 outputs the converted digital signal.

The control unit 1595 is disposed at a subsequent stage of the converter 1594. The control unit 1595 acquires the digital signal output from the converter 1594. The control unit 1595 controls, based on the acquired digital signal, the positions of the light receivers 172 used for communication with the communication target. The control unit 1595 controls the positions of the light receivers 172 used for communication with the communication target in such a way that the light receivers 172 are located at positions where the intensity of the acquired digital signal is highest. By the control, the light receivers 172 associated with the communication target are arranged at the positions where the light reception intensities of the second light receiving elements 1722 are highest.

An example of controlling the positions of the light receivers 172 by the control unit 1595 will be described. An example will be described in which the positions of the light receivers 172 are controlled by combining first position control for controlling the positions of the light receivers 172 in the vertical direction and second position control for controlling the positions of the light receivers 172 in the horizontal plane.

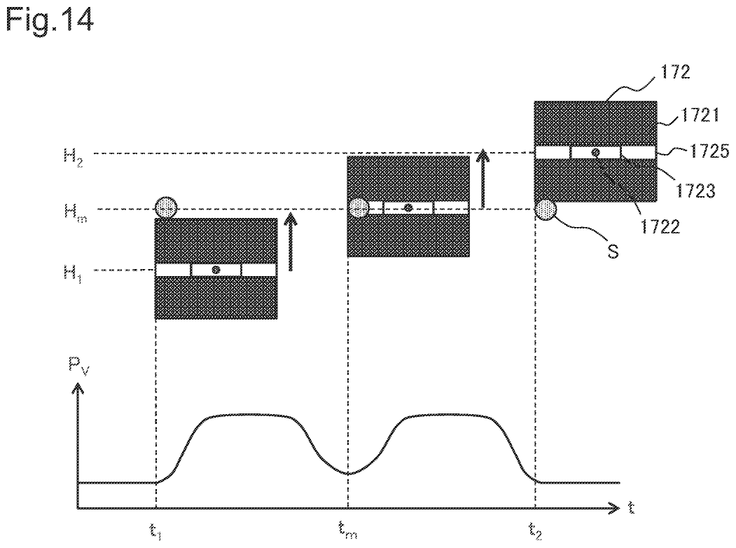

FIG. 14 is a conceptual diagram for describing the first position control for controlling the positions of the light receivers 172 in the vertical direction. FIG. 14 illustrates a state in which the position of the light receiver 172 in the vertical direction changes during the period of the first position control. FIG. 14 conceptually illustrates the position of the light receiver 172 at each of a time t₁, a time tₘ, and a time t₂. FIG. 14 illustrates a graph indicating a time-series change in the intensity P_{V} of the notification light received by the first light receiving element 1721 at each time in the period of the first position control. FIG. 14 illustrates a position (light spot S) of the notification light emitted from the communication target.

In the first position control, the control unit 1595 gradually raises the position of the light receiver 172 in the vertical direction. The first light receiving element 1721 starts to receive the notification light from the time t₁. The intensity P_{V} of the notification light received by the first light receiving element 1721 increases from time t₁ to time tₘ. At a stage where the wiring 1725 reaches the position of the light spot S, the intensity P_{V} of the notification light received by the first light receiving element 1721 decreases. The intensity P_{V} of the notification light received by the first light receiving element 1721 is lowest at the time tₘ. When the wiring 1725 passes through the position of the light spot S, the intensity P_{V} of the notification light received by the first light receiving element 1721 increases again. Then, the intensity P_{V} of the notification light received by the first light receiving element 1721 decreases as the time approaches the time t₂. The first light receiving element 1721 does not receive the notification light in a time zone after the time t₂.

The control unit 1595 stores the position of the light receiver 172 in the vertical direction at the time tₘ when the light intensity P_{V} of the notification light received by the first light receiving element 1721 becomes lowest as the optimum height of the light receiver 172. The control unit 1595 adjusts the position of the light receiver 172 in the vertical direction to a height (adjustment height) at times that are before and after the time tₘ at which the intensity P_{V} of the notification light received by the first light receiving element 1721 is lowest and that are times at which the intensity P_{V} of the notification light received is a sufficient intensity. When the height of the light receiver 172 is adjusted to the position in the vertical direction at the time tₘ, the first light receiving element 1721 cannot receive the notification light. Therefore, the control unit 1595 adjusts the height of the light receiver 172 to the adjustment height, and shifts to the second position control.

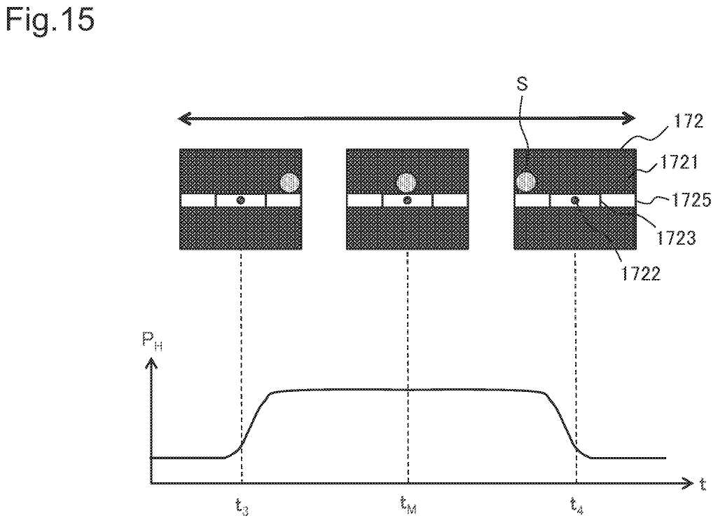

FIG. 15 is a conceptual diagram for describing the second position control for controlling the positions of the light receivers 172 in the horizontal plane. FIG. 15 illustrates a state in which the position of the light receiver 172 in the horizontal plane changes during the period of the second position control. FIG. 15 conceptually illustrates the position of the light receiver 172 at each of a time t₃, a time t_{M}, and a time t₄. FIG. 15 illustrates a graph indicating a time-series change in the intensity P_{H} of the notification light received by the first light receiving element 1721 at each time in the period of the second position control. FIG. 15 illustrates a position (light spot S) of the notification light emitted from the communication target.

At the start time of the second position control, the height of the light receiver 172 is set to the adjustment height adjusted by the first position control. In the second position control, the control unit 1595 gradually changes the position of the light receiver 172 in the horizontal plane. The first light receiving element 1721 starts to receive the notification light from the time t₃. The intensity P_{H} of the notification light received by the first light receiving element 1721 increases from time t₃ to time t_{M}. The intensity P_{H} of the notification light received by the first light receiving element 1721 is highest in a time zone including the time t_{M} that is an intermediate time point between the time t₃ and the time t₄. Then, the intensity P_{H} of the notification light received by the first light receiving element 1721 decreases as the time approaches the time t₄. The first light receiving element 1721 does not receive the notification light in a time zone after the time t₄.

The control unit 1595 stores the position of the light receiver 172 at the time t_{M} that is an intermediate time point between the time t₃ and time t₄ as the optimum position of the light receiver 172. The control unit 1595 adjusts the position of the light receiver 172 in the vertical direction to the optimum height at the time t_{M} when the intensity P_{H} of the notification light received by the first light receiving element 1721 is lowest. The control unit 1595 adjusts the position of the light receiver 172 to the optimum position at the time t_{M} that is the intermediate time point between the time t3 and the time t₄.

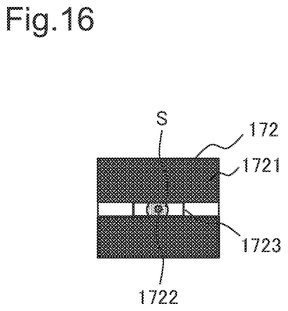

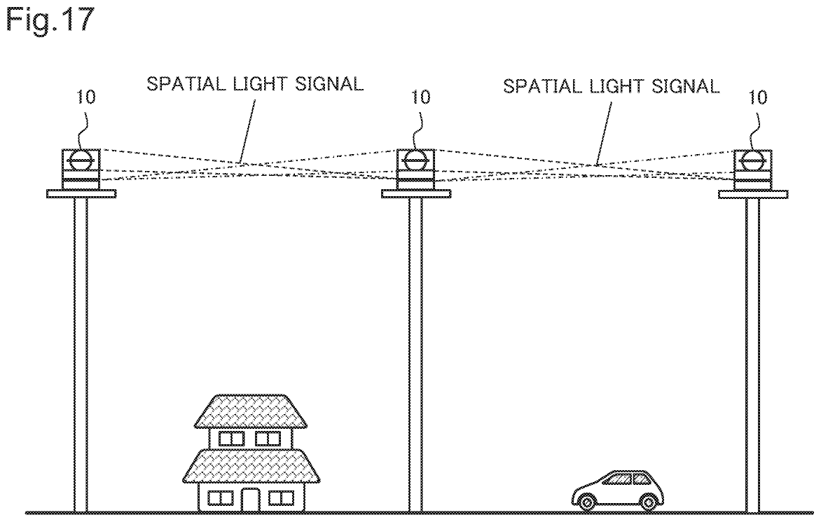

FIG. 16 is a conceptual diagram illustrating a state in which the light spot S of the notification light and a light receiving unit of the second light receiving element 1722 overlap each other by the first position control (FIG. 14) and the second position control (FIG. 15). In the state illustrated in FIG. 16, the communication device 10 receives communication light transmitted from the communication target.

Signals output from the plurality of second light receiving elements 1722 are input to the reception control unit 157. The reception control unit 157 amplifies the input signals. The reception control unit 157 decodes the amplified signals. For example, the reception control unit 157 may perform some signal processing on the decoded signals. The reception control unit 157 outputs the decoded signals to the output unit 159.

The output unit 159 outputs the decoded signals to the outside. For example, the output unit 159 outputs the decoded signals to an external signal processing device or the like (not illustrated). For example, the output unit 159 may cause a display device (not illustrated) to display information corresponding to the decoded signals. The use of the signals output from the output unit 159 is not particularly limited.

### Application Example

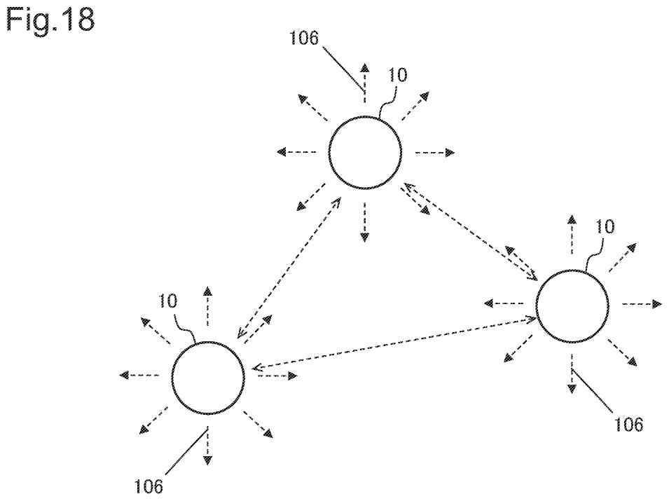

Next, an application example of the present example embodiment will be described with reference to the drawings. In the following application example, an example in which a plurality of communication devices 10 transmit and receive spatial light signals will be described. FIG. 18 is a conceptual diagram for describing the present application. In the present application example, an example (communication system) of a communication network in which a plurality of communication devices 10 are arranged on upper portions (space above poles) of poles such as utility poles or street lamps arranged in a town will be described.

There are few obstacles in the space above the poles. Therefore, the space above the poles is suitable for installation of the communication devices 10. When the communication devices 10 are installed at the same height, arrival directions of the spatial light signals are limited to the horizontal direction. A pair of communication devices 10 that transmit and receive spatial light signals is arranged at positions where at least one communication device 10 can receive the spatial light signal transmitted from the other communication device 10. The pair of communication devices 10 may be arranged to transmit and receive spatial light signals to and from each other. In a case where a communication network for a spatial light signal is configured by the plurality of communication devices 10, a communication device 10 positioned between the other communication devices 10 may be configured to relay a spatial light signal transmitted from one of the other communication devices 10 to the other of the other communication devices 10.

FIG. 18 is a conceptual diagram illustrating a state in which the plurality of communication devices 10 constituting the communication network notify the communication target of the positions of the own devices using notification light 106 (notification light 108). FIG. 18 is a diagram viewed from an upper perspective. The notification light 106 is diffused in directions of 360 degrees in the horizontal plane with each of the communication devices 10 as the center. Therefore, each of the plurality of communication devices 10 arranged at the same height receives the notification light 106 diffused from the other communication devices 10. Each of the communication devices 10 of the present application example can establish communication with the other communication devices 10 by adjusting the positions of the light receivers 172 based on the notification light 106.

According to the present application example, it is possible to perform optical space communication using spatial light signals between the plurality of communication devices 10 arranged in the space above the poles. For example, in addition to the optical space communication between the communication devices 10, communication by radio communication using radio waves may be performed between the communication devices 10 and a base station or a radio device installed in an automobile, a house, or the like. For example, the communication devices 10 may be connected to the Internet via communication cables or the like installed on the poles.

As described above, the communication device according to the present example embodiment includes the transmitting device, the communication control device, and the receiving device. The transmitting device of the present example embodiment includes the first light source, the spatial light modulator, the curved mirror, and the second light sources. The first light source includes the plurality of light emitters. The spatial light modulator includes the modulation part. The plurality of modulation regions are set in the modulation part. Each of the plurality of modulation regions is irradiated with illumination light derived from light emitted from each of the plurality of light emitters. The curved mirror is disposed in the optical path for light modulated in any one of the plurality of modulation regions. The curved mirror has the curved reflecting surface. The curved reflecting surface reflects the light modulated in each of the plurality of modulation regions toward an arbitrary direction along the horizontal plane. Each of the plurality of second light sources includes a light emitting diode. Each of the plurality of second light sources emits notification light modulated with the modulation frequency unique to the communication device.

The receiving device of the present example embodiment includes the ball lens, the plurality of light receivers, the notification light transmitter, and the moving mechanism. The ball lens is disposed below the notification light transmitter. Each of the plurality of light receivers is disposed in the condensing region of the ball lens. Each of the light receivers includes the first light receiving element and the second light receiving element. The first light receiving elements receive notification light transmitted from the communication target. The second light receiving elements receive communication light transmitted from the communication target. The moving mechanism includes the support columns and the base. The ball lens is disposed on the base of the moving mechanism. The moving mechanism movably supports the plurality of light receivers in accordance with the condensing region of the ball lens. The notification light transmitter includes the third light sources that transmit the notification light in a direction along the horizontal plane. For example, each of the third light sources includes a light emitting diode and transmits notification light modulated with a unique modulation frequency.

The communication control device according to the present example embodiment causes either the receiving device or the transmitting device to transmit notification light. The communication control device acquires a signal based on the communication light received by the receiving device. The communication control device executes processing according to the acquired signal. The communication control device causes the transmitting device to transmit communication light corresponding to the executed processing.

The communication device according to the present example embodiment includes the notification light transmitter that transmits notification light in a direction along the horizontal plane. In the communication device according to the present example embodiment, the first light receiving element receives notification light transmitted from another communication target. The positions of the light receivers can be changed in accordance with the arrival position of the notification light transmitted from the other communication target. The second light receiving elements of the light receivers whose positions have been changed in accordance with the arrival position of the notification light receive communication light transmitted from the communication target. Therefore, the communication device according to the present example embodiment can implement spatial light communication using a spatial light signal with the communication target in directions of 360 degrees along the horizontal plane.

In one aspect of the present example embodiment, the moving mechanism includes the base, the circular rail, and the support columns. The ball lens is disposed on the base. The circular rail is disposed on the upper surface of the base. The circular rail has the circumference overlapping with the condensing region of the ball lens in plan view. The lower ends of the support columns are movably connected to the circular rail. The light receivers are disposed on upper ends of the support columns. The support columns extend and contract in the vertical direction. According to the present aspect, the positions of the light receivers in the vertical direction can be changed by moving the support columns up and down. According to the present aspect, the positions of the light receivers in the horizontal direction can be changed by moving the support columns along the circular rail.

The receiving device according to the aspect of the present example embodiment includes the light receiving position adjustment unit. The light receiving position adjustment unit acquires signals output from the first light receiving elements according to the reception of the notification light transmitted from the communication target. The light receiving position adjustment unit executes the first position control and the second position control. In the first position control, the light receiving position adjustment unit extends and contracts the support columns in the vertical direction to control the positions of the light receivers in the vertical direction. In the second position control, the light receiving position adjustment unit moves the support columns along the circular rail to control the positions of the light receivers in the horizontal direction. The light receiving position adjustment unit adjusts the positions of the light receivers based on the acquired intensity of the received notification light. According to the present aspect, the light receivers can be oriented toward the communication target and adjusted to optimal positions by the first position control and the second position control.

A communication system according to an aspect of the present example embodiment includes the plurality of communication devices described above. In the communication system, the plurality of communication devices are arranged to transmit and receive spatial light signals to and from each other. According to the present aspect, it is possible to implement a communication network in which a spatial light signal is transmitted and received.

### Second Example Embodiment

Next, a transmitting device according to a second example embodiment will be described with reference to the drawings. The transmitting device according to the present example embodiment does not include a function of transmitting notification light. The transmitting device according to the present example embodiment is incorporated in the communication device according to the first example embodiment. The communication device including the transmitting device according to the present example embodiment includes a receiving device including a function of transmitting notification light, and a communication control device that controls the transmitting device and the receiving device. The receiving device and the communication control device have the same configurations as those described in the first example embodiment. In the description of the present example embodiment, description of the receiving device and the communication control device is omitted.

### (Configuration)

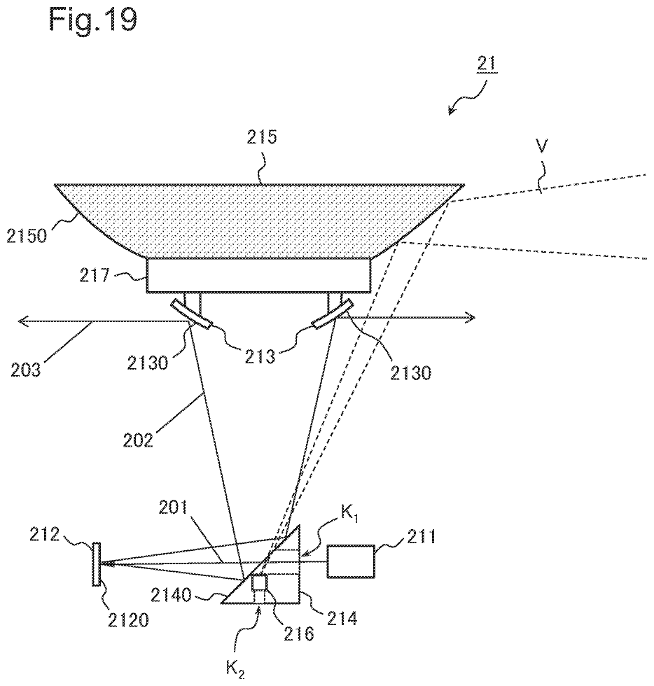

FIG. 19 is a conceptual diagram illustrating an example of a configuration of a transmitting device 21 according to the present disclosure. FIG. 19 is a diagram of an internal configuration of the transmitting device 21 as viewed from a side perspective. The transmitting device 21 includes a first light source 211, a spatial light modulator 212, curved mirrors 213, a relay reflector 214, a light receiving mirror 215, a camera 216, and a support 217. The transmitting device 21 includes the plurality of curved mirrors 213. The transmitting device 21 is disposed inside a housing (not illustrated) in which an opening or a window for transmitting and receiving a spatial light signal is formed.

The first light source 211 has a configuration similar to that of the first light source 111 described in the first example embodiment. The first light source 211 emits illumination light 201. An emission surface of the first light source 211 is directed to a modulation part 2120 of the spatial light modulator 212 via a first through-hole K₁ formed in the relay reflector 214. The illumination light 201 emitted from the first light source 211 passes through the first through-hole K₁ formed in the relay reflector 214 and is applied to the modulation part 2120 of the spatial light modulator 212. The first light source 211 may be disposed inside the first through-hole K, formed in the relay reflector 214.

The spatial light modulator 212 has the same configuration as the spatial light modulator 112 described in the first example embodiment. The spatial light modulator 212 is a phase modulation type spatial light modulator. The spatial light modulator 212 includes the modulation part 2120. A plurality of modulation regions are set in the modulation part 2120. A pattern (also referred to as a phase image) corresponding to an image displayed by communication light 203 is set in each of the plurality of modulation regions under the control of a communication control device (not illustrated). The illumination light 201 incident on each of the plurality of modulation regions is modulated according to the pattern (phase image) set in each of the plurality of modulation regions. Light 202 modulated in each of the plurality of modulation regions travels toward a relay reflecting surface 2140 of the relay reflector 214.

The relay reflector 214 has an outer shape of a right angle prism. The relay reflecting surface 2140 is formed on a slope of the relay reflector 214. The inclination angle of the relay reflecting surface 2140 is 45 degrees. The relay reflector 214 is disposed between the first light source 211 and the spatial light modulator 212. The relay reflector 214 is disposed below the support 217 that supports the light receiving mirror 215. The first through-hole K₁ is formed in the relay reflector 214. In the example illustrated in FIG. 19, the first through-hole K₁ penetrates the relay reflector 214 in a left-right direction in a surface of paper on which FIG. 19 is drawn. A second through-hole K₂ is formed in the relay reflector 214. In the example illustrated in FIG. 19, the second through-hole K₂ penetrates the relay reflector 214 in a top-bottom direction in the surface of the paper on which FIG. 19 is drawn. The camera 216 is disposed inside the second through-hole K₂.

The light 202 modulated in each of the plurality of modulation regions set in the modulation part 2120 of the spatial light modulator 212 travels toward the relay reflecting surface 2140 of the relay reflector 214. The modulated light 202 reaching the relay reflecting surface 2140 is reflected by the relay reflecting surface 2140. The modulated light 202 reflected by the relay reflecting surface 2140 travels toward a reflecting surface 2130 of any one of the plurality of curved mirrors 213 supported by the support 217.

The curved mirrors 213 have the same configuration as that of the curved mirror 113 described in the first example embodiment. Each of the curved mirrors 213 is a reflector having a curved reflecting surface 2130. The curved mirrors 213 are disposed at a subsequent stage of the spatial light modulator 212. The curved mirrors 213 are disposed on a lower surface of the support 217. A circular rail (not illustrated) having a circular shape is arranged on the lower surface of the support 217. The curved mirrors 213 are installed in such a way as to be movable along the circular rail. The positions of the curved mirrors 213 are changed under the control of the communication control device 15. The positions of the curved mirrors 213 are changed in response to the detection of notification light from a communication target in such a way that the reflecting surfaces 2130 faces toward the arrival direction of the notification light.

The reflecting surfaces 2130 of the curved mirrors 213 have a curvature corresponding to a projection angle at which the communication light 203 is projected. For example, each of the reflecting surfaces 2130 has a shape of a side surface of a cylinder. For example, each of the reflecting surfaces 2130 may be a free-form surface or a spherical surface. For example, each of the reflecting surfaces 2130 may not be a single curved surface but may have a shape obtained by combining a plurality of curved surfaces. Each of the reflecting surfaces 2130 may be a flat surface. In a case where each of the reflecting surfaces 2130 is a flat surface, an adjustment range of the projection angle at which the communication light 203 is projected is narrower than that when the reflecting surfaces 2130 are curved surfaces. In a case where each of the reflecting surfaces 2130 is a flat surface, the communication light 203 reaches a far place because the spread of the communication light 203 is small, as compared with a case where the reflecting surfaces 2130 are curved surfaces. For example, each of the reflecting surfaces 2130 may have a shape obtained by combining a curved surface and a flat surface.

The curved mirrors 213 are disposed with the reflecting surfaces 2130 facing the modulation part 2120 of the spatial light modulator 212. The curved mirrors 213 are disposed in the optical path of the modulated light 202. The reflecting surfaces 2130 of the curved mirrors 213 are irradiated with the modulated light 202. The light (communication light 203) reflected by each of the reflecting surfaces 2130 is projected as a spatial light signal. The communication light 203 is enlarged according to the curvature of an irradiation range of the modulated light 202 on the reflecting surfaces 2130 of the curved mirrors 213. For example, a lens (not illustrated) may be disposed at a subsequent stage of the curved mirrors 213 in order to limit the spread of the communication light 203.

The light 202 modulated by the modulation part 2120 of the spatial light modulator 212 includes an unnecessary light component (also referred to as unnecessary light). The unnecessary light is zero-order light or high-order light included in the modulated light 202. The curved mirrors 213 are disposed at positions where the reflecting surfaces 2130 are not irradiated with the unnecessary light. The reflecting surfaces 2130 are irradiated with a light component (also referred to as desired light) to be projected out of the light 202 modulated by the modulation part 2120. The modulated light 202 applied to the reflecting surfaces 2130 is reflected by the reflecting surfaces 2130. The light (communication light 203) reflected by the reflecting surfaces 2130 is enlarged and projected at an enlargement ratio corresponding to the curvature of the reflecting surfaces 2130. The communication light 203 spreads as the communication light 203 goes away from the transmitting device 21.

The reflecting surfaces 2130 of the curved mirrors 213 are oriented in directions of 360 degrees in the horizontal plane. Therefore, the transmitting device 21 can project the communication light 203 in the directions of 360 degrees in the horizontal plane by controlling the patterns (phase images) set in the modulation part 2120 of the spatial light modulator 212. The transmitting device 21 can simultaneously transmit the communication light 203 (spatial light signal) toward communication targets arranged in a plurality of directions by associating the plurality of modulation regions set in the modulation part 2120 with different directions.

The light receiving mirror 215 is a reflector having a curved light receiving/reflecting surface 2150. The light receiving mirror 215 has a circular shape in plan view. The light receiving mirror 215 has a circular upper surface (first surface) having a first radius and a circular lower surface (second surface) having a second radius smaller than the first radius. The light receiving mirror 215 is disposed above the support 217 in such a way that the lower surface (second surface) faces downward. The center of a circle on the upper surface coincides with the center of a circle on the lower surface. A side surface of the light receiving mirror 215 forms a smooth curved surface from the upper surface toward the lower surface. The side surface (curved surface) of the light receiving mirror 215 is the light receiving/reflecting surface 2150. That is, the light receiving mirror 215 is a reflecting mirror having the curved light receiving/reflecting surface 2150.

The light receiving/reflecting surface 2150 of the light receiving mirror 215 has a curvature in such a way that the light receiving/reflecting surface 2150 reflects light V arriving from a direction along the horizontal plane toward the second through-hole K₂ of the relay reflector 214. The shape of the light receiving/reflecting surface 2150 of the light receiving mirror 215 is not limited. For example, the light receiving/reflecting surface 2150 of the light receiving mirror 215 may be a free-form surface or a spherical surface. For example, the light receiving/reflecting surface 2150 of the light receiving mirror 215 may have a shape obtained by combining a plurality of curved surfaces instead of a single curved surface. The light receiving/reflecting surface 2150 may be a flat surface. For example, the light receiving/reflecting surface 2150 of the light receiving mirror 215 may have a shape obtained by combining a curved surface and a flat surface.

The light V arriving at the transmitting device 21 from the direction along the horizontal plane is reflected by the light receiving/reflecting surface 2150 of the light receiving mirror 215, and is imaged by the camera 216 arranged in the second through-hole K₂ of the relay reflector 214.

The camera 216 is disposed in the second through-hole K₂ of the relay reflector 214 in such a way that a lens of the camera 216 faces upward. As long as a digital image can be captured, the type and specifications of the camera 216 are not limited. The camera 216 captures an image of the light V reflected by the light receiving/reflecting surface 2150 of the light receiving mirror 215. The camera 216 outputs image data corresponding to the captured light V to a communication control device (not illustrated). The image data captured by the camera 216 is used for detection of radiation light emitted from the communication target.

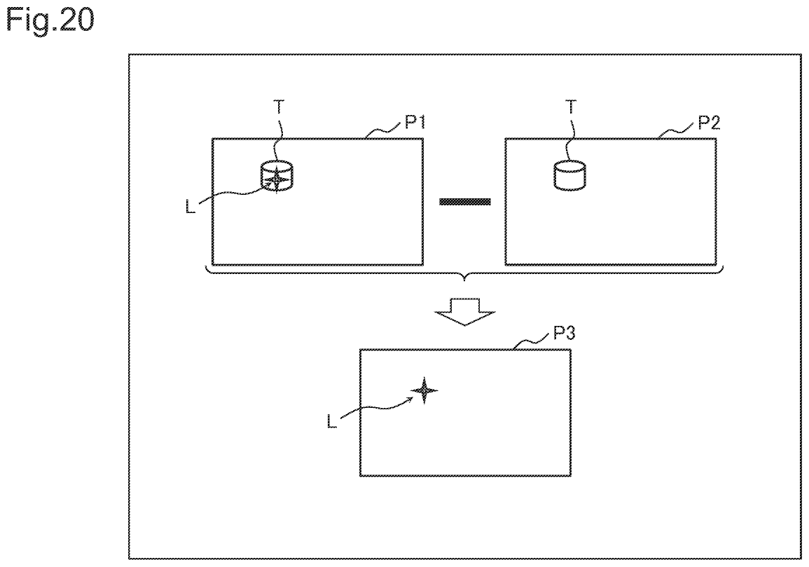

FIG. 20 is a conceptual diagram for describing an example of detection of a communication target using image data captured by the camera 216. The communication target illustrated in FIG. 20 has a configuration similar to that of the communication device 10 according to the first example embodiment. Image data P1 is an image showing the communication target T and notification light L emitted from the communication target T. Image data P2 is an image showing the communication target T. Image data P3 is image data obtained by taking a difference between the image data P1 and the image data P2. The notification light L emitted from the communication target T remains in the image data P3. That is, the notification light L is detected by taking a difference between the image data captured at different timings.

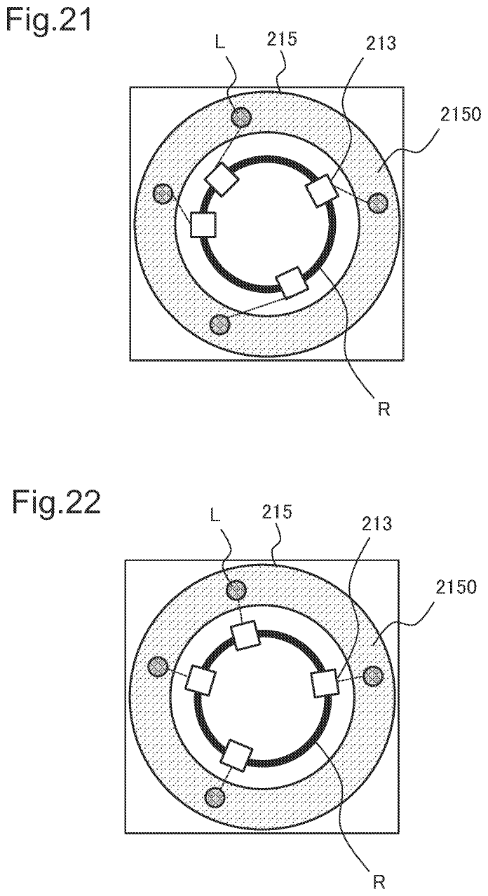

FIG. 21 is a conceptual diagram for describing an example of reception of the notification light L by the transmitting device 21. FIG. 21 is a diagram viewed upward from a perspective of the camera 216. The image data captured by the camera 216 includes the plurality of curved mirrors 213, the circular rail R, and the light receiving/reflecting surface 2150 of the light receiving mirror 215. In the image data captured by the camera 216, notification lights L emitted from a plurality of communication targets are included at the position of the light receiving/reflecting surface 2150. FIG. 21 illustrates dotted lines indicating association between the plurality of notification lights L and the plurality of curved mirrors 213. In the state illustrated in FIG. 21, the plurality of notification lights L and the plurality of curved mirrors 213 are not associated with each other. In this state, spatial light communication using communication light cannot be performed with the communication targets that are radiation sources of the plurality of notification lights L. Therefore, the transmitting device 21 changes the positions of the plurality of curved mirrors 213 in such a way as to associate the plurality of notification lights L with the plurality of curved mirrors 213.

FIG. 22 is a conceptual diagram for describing an example in which the positions of the plurality of curved mirrors are adjusted according to the reception of the notification lights L by the transmitting device 21. FIG. 22 is a diagram viewed upward from a perspective of the camera 216. FIG. 22 illustrates dotted lines indicating association between the plurality of notification lights L and the plurality of curved mirrors 213. In the state illustrated in FIG. 22, the plurality of notification lights L and the plurality of curved mirrors 213 are associated with each other. In this state, spatial light communication using communication light can be performed with the communication targets that are the radiation sources of the plurality of notification lights L.

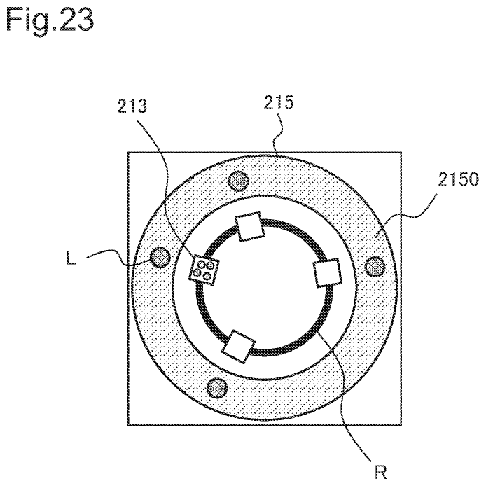

FIG. 23 is a conceptual diagram for describing processing of establishing spatial light communication using communication light with communication targets. In a stage of establishing spatial light communication using communication light, first, spatial light communication with a single communication target is established using the plurality of light emitters included in the first light source 211. That is, in the stage of establishing spatial light communication using communication light, positioning of the light receivers (not illustrated) included in the receiving device is performed using a plurality of communication lights. Details of the processing of positioning the light receivers (not illustrated) included in the receiving device using the plurality of communication lights will not be described. In this way, by performing the processing described with reference to FIGS. 21 to 23, spatial light communication using communication lights with the plurality of communication targets is established.

### Modifications

Next, a first modification of the present example embodiment will be described with reference to the drawings. The present modification differs from the configuration illustrated in FIG. 19 in the configurations of the light receiving mirror 215 and the support 217. Hereinafter, the description of the same configurations those illustrated in FIG. 19 will be omitted.

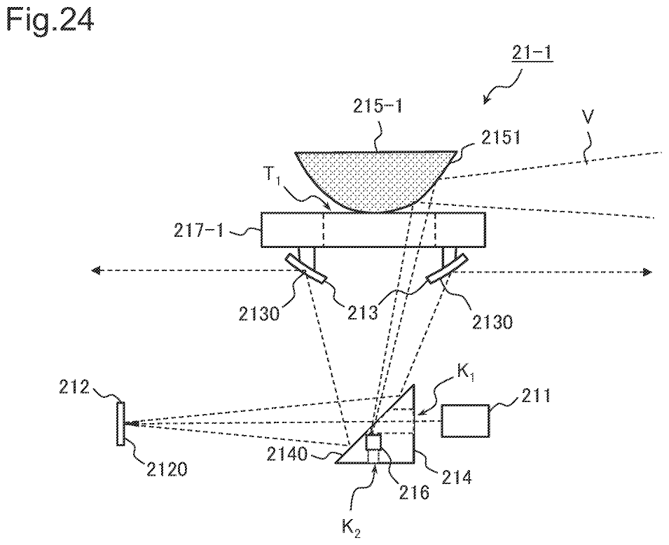

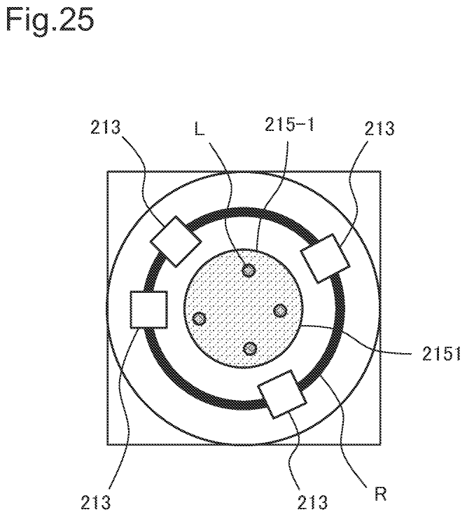

FIG. 24 is a conceptual diagram illustrating an example of a configuration of a transmitting device 21-1 according to the present modification. FIG. 24 is a diagram of an internal configuration of the transmitting device 21-1 as viewed from a side perspective. The transmitting device 21-1 includes a first light source 211, a spatial light modulator 212, curved mirrors 213, a relay reflector 214, a light receiving mirror 215-1, a camera 216, and a support 217-1. The transmitting device 21-1 includes the plurality of curved mirrors 213. The transmitting device 21-1 is disposed inside a housing (not illustrated) in which an opening or a window for transmitting and receiving a spatial light signal is formed. The first light source 211, the spatial light modulator 212, the curved mirrors 213, the relay reflector 214, and the camera 216 have the same configurations as those illustrated in FIG. 19.

The light receiving mirror 215-1 is a reflector having a curved light receiving/reflecting surface 2151. The light receiving mirror 215-1 has a circular shape in plan view. The light receiving mirror 215-1 has a circular upper surface (first surface) having a first radius and a curved lower surface (reflecting surface 2151). The light receiving mirror 215-1 is disposed above a through-hole Ti of the support 217-1 in such a way that the lower surface (reflecting surface 2151) faces downward. The lower surface of the light receiving mirror 215-1 forms a smooth curved surface from the peripheral edge toward the center. The light receiving mirror 215-1 is a reflector having the curved reflecting surface 2151.

The reflecting surface 2151 of the light receiving mirror 215-1 has a curvature in such a way that the reflecting surface 2151 reflects light V arriving from a direction along the horizontal plane toward a second through-hole K₂ of the relay reflector 214 via the through-hole Ti of the support 217-1. The shape of the reflecting surface 2151 of the light receiving mirror 215-1 is not limited. For example, the reflecting surface 2151 of the light receiving mirror 215-1 may be a free-form surface or a spherical surface. For example, the reflecting surface 2151 of the light receiving mirror 215-1 may not have a single curved surface but may have a shape obtained by combining a plurality of curved surfaces. The reflecting surface 2151 may be a flat surface. For example, the reflecting surface 2151 of the light receiving mirror 215-1 may have a shape obtained by combining a curved surface and a flat surface.

The light V arriving at the transmitting device 21-1 from the direction along the horizontal plane is reflected by the reflecting surface 2151 of the light receiving mirror 215-1, and is imaged by the camera 216 disposed in the second through-hole K₂ of the relay reflector 214.

FIG. 25 is a conceptual diagram for describing an example of reception of notification light L by the transmitting device 21. FIG. 25 is a diagram viewed upward from a perspective of the camera 216. In the example illustrated in FIG. 25, the reflecting surface 2151 of the light receiving mirror 215-1 can be seen through the second through-hole K₂ of the relay reflector 214. Image data captured by the camera 216 includes the plurality of curved mirrors 213, the circular rail R, and the reflecting surface 2151 of the light receiving mirror 215-1. In the image data captured by the camera 216, notification lights L emitted from a plurality of communication targets are included at the position of the reflecting surface 2151. In the state illustrated in FIG. 25, the plurality of notification lights L and the plurality of curved mirrors 213 are not associated with each other. In this state, spatial light communication using communication light cannot be performed with the communication targets that are radiation sources of the plurality of notification lights L. Therefore, similarly to the processing described with reference to FIGS. 21 to 23, the transmitting device 21 changes the positions of the plurality of curved mirrors 213 in such a way as to associate the plurality of notification lights L with the plurality of curved mirrors 213. The processing thereafter is similar to the processing described with reference to FIGS. 21 to 23, and thus description thereof is omitted.

As described above, the transmitting device according to the present example embodiment includes the first light source, the spatial light modulator, the relay reflector, the camera, the curved mirrors, and the light receiving mirror. The first light source includes a plurality of light emitters. The first light source is disposed at a position where illumination light passes through the first through-hole of the relay reflector toward the relay reflecting surface. The spatial light modulator is disposed at a position where the relay reflecting surface of the relay reflector and a modulation part face each other and modulated light obtained by modulating the illumination light emitted from the first light source is reflected toward the relay reflecting surface. The spatial light modulator includes the modulation part. A plurality of modulation regions are set in the modulation part. Each of the plurality of modulation regions is irradiated with illumination light derived from light emitted from each of the plurality of light emitters. The relay reflector is disposed between the first light source and the spatial light modulator. The relay reflector is disposed at a position where the light modulated by the modulation part of the spatial light modulator is reflected toward the reflecting surfaces of the curved mirrors. The relay reflector has an outer shape of a right angle prism in which a relay reflecting surface is formed on an inclined surface. The first through-hole penetrating the relay reflecting surface along the horizontal direction and the second through-hole penetrating the relay reflecting surface along the vertical direction are formed in the relay reflector. The curved mirrors are movably arranged in accordance with an optical path of modulated light reflected by the relay reflecting surface of the relay reflector out of light modulated in any one of the plurality of modulation regions. The curved mirrors has the curved reflecting surfaces. The curved reflecting surfaces reflect the modulated light reflected by the relay reflecting surface of the relay reflector in a direction along the horizontal plane. The camera is disposed in the second through-hole of the relay reflector in such a way that a lens of the camera faces upward. The light receiving mirror has the light receiving/reflecting surface. The light receiving/reflecting surface reflects light arriving from the horizontal direction toward the second through-hole.

The transmitting device according to the present example embodiment includes the light receiving mirror that reflects light arriving from a direction along the horizontal plane. The light receiving mirror reflects light arriving from a direction along the horizontal plane toward the second through-hole in which the camera is disposed. The camera captures an image of a direction of light coming from a direction along the horizontal plane. Therefore, the transmitting device according to the present example embodiment can detect notification light transmitted from a communication target arranged in the direction along the horizontal plane.

In one aspect of the present example embodiment, the communication control device connected to the transmitting device detects notification light transmitted from a communication target according to a difference between a plurality of pieces of image data captured by the camera at different timings. According to the present aspect, the notification light transmitted from the communication target can be detected based on the difference between the plurality of pieces of image data captured by the camera.

In one aspect of the present example embodiment, the communication control device connected to the transmitting device adjusts the positions of the curved mirrors in accordance with the direction of the detected notification light. The communication control device controls the transmitting device to emit illumination light from the plurality of light emitters included in the first light source toward the curved mirrors whose positions have been changed. The communication control device causes the transmitting device to transmit communication light for establishing communication with the communication target that is the transmission source of the detected notification light. According to the present aspect, communication light can be transmitted toward the communication target by adjusting the positions of the curved mirrors in accordance with the direction of the notification light.

### Third Example Embodiment

Next, a receiving device according to a third example embodiment will be described with reference to the drawings. The receiving device according to the present example embodiment has a similar configuration to that of the receiving device 17 according to the first example embodiment.

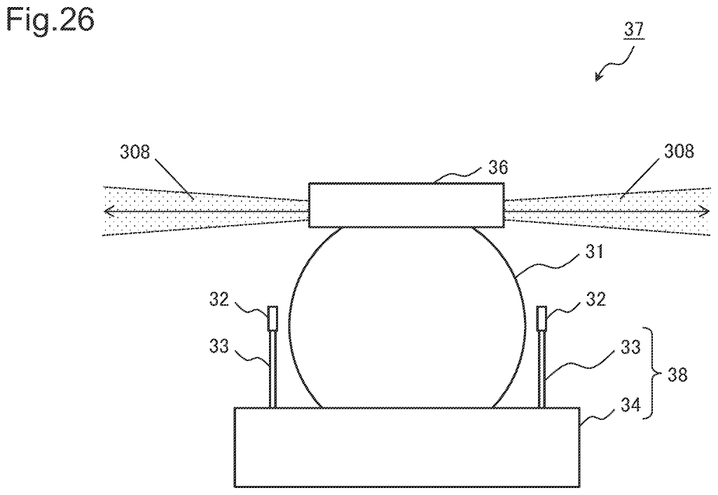

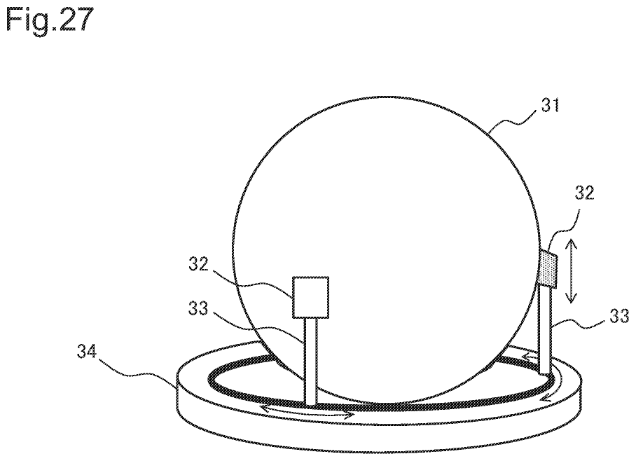

FIGS. 26 and 27 are conceptual diagrams illustrating an example of a configuration of a receiving device 37 according to the present disclosure. FIG. 26 is a side view of the receiving device 37 as viewed from a side perspective. FIG. 27 is a perspective view of the receiving device 37 as viewed from an obliquely upper perspective. The receiving device 37 includes a ball lens 31, a plurality of light receivers 32, a notification light transmitter 36, and a moving mechanism 38.

The ball lens 31 is disposed below the notification light transmitter 36. Each of the plurality of light receivers 32 is disposed in a condensing region of the ball lens 31. Each of the light receivers 32 includes a first light receiving element and a second light receiving element. The first light receiving elements receive notification light transmitted from a communication target. The second light receiving elements receive communication light transmitted from the communication target. The moving mechanism 38 includes support columns 33 and a base 34. The ball lens 31 is disposed on the base 34 of the moving mechanism 38. The moving mechanism 38 movably supports the plurality of light receivers 32 in accordance with the condensing region of the ball lens 31. The notification light transmitter 36 transmits notification light in a direction along the horizontal plane.

The receiving device according to the present example embodiment includes the notification light transmitter that transmits notification light in a direction along the horizontal plane. In the receiving device according to the present example embodiment, the first light receiving elements receive notification light transmitted from another communication target. The positions of the light receivers can be changed in accordance with the arrival position of the notification light transmitted from the other communication target. The second light receiving elements of the light receivers whose positions have been changed in accordance with the arrival position of the notification light receive communication light transmitted from the communication target.

Therefore, the receiving device according to the present example embodiment can implement spatial light communication using a spatial light signal with a communication target in directions of 360 degrees along the horizontal plane.

### (Hardware)

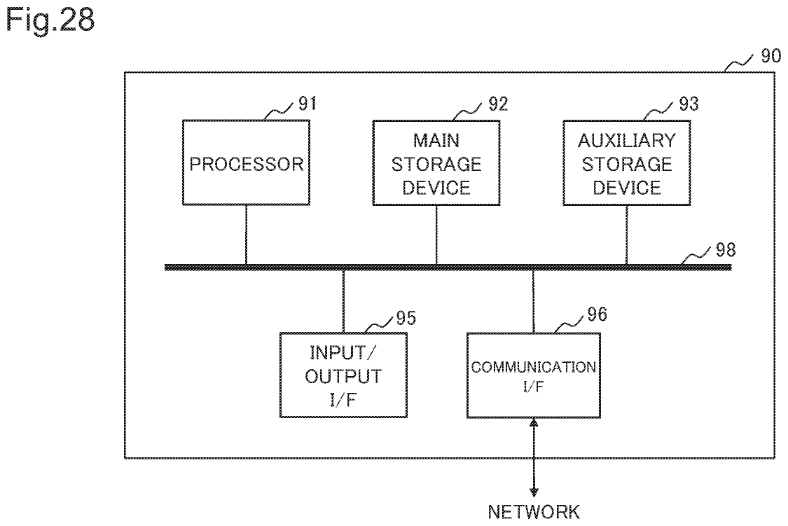

Next, a hardware configuration for executing the control and the processing according to the present disclosure will be described with reference to the drawings. An example of the hardware configuration is an information processing device 90 (computer) illustrated in FIG. 28. The information processing device 90 illustrated in FIG. 28 is a configuration example for executing the control and the processing according to the present disclosure, and does not limit the scope of the present disclosure.

As illustrated in FIG. 28, the information processing device 90 includes a processor 91, a main storage device 92, an auxiliary storage device 93, an input/output interface 95, and a communication interface 96. In FIG. 28, the interface is abbreviated as an I/F. The processor 91, the main storage device 92, the auxiliary storage device 93, the input/output interface 95, and the communication interface 96 are communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like into the main storage device 92. For example, the program is a software program for executing the control and the processing according to the present disclosure. The processor 91 executes the program developed in the main storage device 92. The processor 91 executes the program to execute the control and the processing according to the present disclosure.

The main storage device 92 has a region into which the program is developed.

The program stored in the auxiliary storage device 93 or the like is developed into the main storage device 92 by the processor 91. The main storage device 92 is implemented by, for example, a volatile memory such as a dynamic random access memory (DRAM).

A nonvolatile memory such as a magnetoresistive random access memory (MRAM) may be configured or added as the main storage device 92.

The auxiliary storage device 93 stores various data such as the program. The auxiliary storage device 93 is implemented by a local disk such as a hard disk or a flash memory. Various data may be stored in the main storage device 92, and the auxiliary storage device 93 may be omitted.

The input/output interface 95 is an interface for connecting the information processing device 90 to a peripheral device based on a standard or a specification. The communication interface 96 is an interface for connecting to an external system or device via a network such as the Internet or an intranet based on a standard or a specification. The input/output interface 95 and the communication interface 96 may be shared as an interface connected to an external device.

Input devices such as a keyboard, a mouse, and a touch panel may be connected to the information processing device 90 as necessary. These input devices are used to input information and settings. When a touch panel is used as the input device, a screen having a touch panel function serves as the interface. The processor 91 and the input devices are connected via the input/output interface 95.

The information processing device 90 may be provided with a display device for displaying information. In a case where the information processing device 90 is provided with the display device, the information processing device 90 includes a display control device (not illustrated) for controlling display of the display device. The information processing device 90 and the display device are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via the input/output interface 95.

The above-described hardware configuration is an example of the hardware configuration for enabling the control and the processing according to the present disclosure. The hardware configuration illustrated in FIG. 28 is an example of the hardware configuration for executing the control and the processing according to the present disclosure, and does not limit the scope of the present disclosure. The program for causing a computer to execute the control and the processing according to the present disclosure is also included in the scope of the present disclosure.

A program recording medium in which the program according to the present disclosure is recorded is also included in the scope of the present disclosure. The recording medium can be implemented by, for example, an optical recording medium such as a compact disc (CD) or a digital versatile disc (DVD). The recording medium may be implemented by a semiconductor recording medium such as a Universal Serial Bus (USB) memory or a secure digital (SD) card. The recording medium may be implemented by a magnetic recording medium such as a flexible disk, or another recording medium. When the program executed by the processor is recorded in the recording medium, the recording medium corresponds to the program recording medium.

The components of the present disclosure may be arbitrarily combined. The components of the present disclosure may be implemented by software. The components of the present disclosure may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A receiving device comprising:
a notification light transmitter configured to transmit notification light in a direction along a horizontal plane;
a ball lens disposed below the notification light transmitter;
a plurality of light receivers each including a first light receiving element disposed in a condensing region of the ball lens and configured to receive notification light transmitted from a communication target, and a second light receiving element configured to receive communication light transmitted from the communication target; and
a moving mechanism on which the ball lens is disposed and that is configured to movably support the plurality of light receivers in accordance with the condensing region of the ball lens.

2. The receiving device according to claim 1, wherein
the notification light transmitter includes
a light emitting diode and
transmits notification light modulated with a unique modulation frequency.

3. The receiving device according to claim 2, wherein
the moving mechanism includes:
a base on which the ball lens is disposed;
a circular rail disposed on an upper surface of the base and having a circumference overlapping the condensing region of the ball lens in a plan view; and
a support column that has a lower end movably connected on the circular rail and an upper end on which the light receivers are disposed, and extends and contracts in a vertical direction.

4. The receiving device according to claim 3, further comprising
a first memory storing instructions, and
a first processor connected to the first memory and configured to execute the instructions to:
acquire a signal output from the first light receiving elements according to reception of the notification light transmitted from the communication target,
execute first position control of extending and contracting the support column in the vertical direction to control positions of the light receivers in the vertical direction and second position control of moving the support column along the circular rail to control positions of the light receivers in a horizontal direction, and
adjust positions of the light receivers based on an intensity of the received acquired notification light.

5. A communication device comprising:
the receiving device according to claim 1;
a transmitting device configured to transmit communication light toward a communication target; and
a communication control device comprising
a second memory storing instructions; and
a second processor connected to the second memory and configured to execute the instructions to
cause one of the receiving device and the transmitting device to transmit notification light,
acquire a signal based on the notification light received by the receiving device and the communication light received by the receiving device,
execute processing according to the acquired signal, and
cause the transmitting device to transmit communication light according to the executed processing.

6. The communication device according to claim 5, wherein
the transmitting device includes:
a first light source including a plurality of light emitters;
a spatial light modulator including a modulation part in which a plurality of modulation regions to be irradiated with illumination light derived from light emitted from each of the plurality of light emitters are set;
a curved mirror that is disposed in an optical path for light modulated in any one of the plurality of modulation regions and has a curved reflecting surface that reflects the light modulated in each of the plurality of modulation regions toward an arbitrary direction along a horizontal plane; and
a plurality of second light sources that include a light emitting diode and are configured to emit notification light modulated with a unique modulation frequency.

7. The communication device according to claim 5, wherein
the transmitting device includes:
a first light source including a plurality of light emitters;
a spatial light modulator including a modulation part in which a plurality of modulation regions to be irradiated with illumination light derived from light emitted from each of the plurality of light emitters are set;
a relay reflector disposed between the first light source and the spatial light modulator, having an outer shape of a right angle prism in which a relay reflecting surface is formed on an inclined surface, and having, formed in the relay reflector, a first through-hole penetrating the relay reflecting surface in a horizontal direction and a second through-hole penetrating the relay reflecting surface in a vertical direction;
a curved mirror arranged movably in accordance with an optical path for modulated light reflected by the relay reflecting surface of the relay reflector out of light modulated in any one of the plurality of modulation regions, the curved mirror having a curved reflecting surface that reflects the modulated light reflected by the relay reflecting surface of the relay reflector in a direction along a horizontal plane;
a camera disposed in the second through-hole of the relay reflector in such a way that an imaging direction of the camera faces upward; and
a light receiving mirror having a light receiving/reflecting surface that reflects light arriving from a horizontal direction toward the second through-hole, wherein
the first light source is disposed at a position where the illumination light passes through the first through-hole of the relay reflector toward the relay reflecting surface,
the spatial light modulator is disposed at a position where the relay reflecting surface of the relay reflector and the modulation part face each other and the modulated light obtained by modulating the illumination light emitted from the first light source is reflected toward the relay reflecting surface, and
the relay reflector is disposed at a position where the light modulated by the modulation part of the spatial light modulator is reflected toward the reflecting surface of the curved mirror.

8. The communication device according to claim 7, wherein
the second processor of the communication control device is configured to execute the instructions to
detect notification light transmitted from the communication target in accordance with a difference between a plurality of pieces of image data captured by the camera at different timings.

9. The communication device according to claim 8, wherein
the second processor of the communication control device is configured to execute the instructions to
adjust a position of the curved mirror in accordance with a direction of the detected notification light,
control the transmitting device to emit the illumination light from the plurality of light emitters included in the first light source toward the curved mirror whose position has been changed, and
cause the transmitting device to transmit communication light for establishing communication with the communication target that is a transmission source of the detected notification light.

10. A communication system comprising a plurality of communication devices according to claim 5, wherein
the plurality of communication devices are arranged to transmit and receive spatial light signals to and from each other.
